(19) United States
(12) Patent Application Publication
(10) Pub. No.: US 2022/0348037 A1
(43) Pub. Date: Nov. 3, 2022

(54) METHOD FOR APPLYING A SLIP-RESISTANT, WATER-RESISTANT, ANTIBACTERIAL SURFACE TO SPORTING EQUIPMENT

(71) Applicant: Melissa Gronda LLC, Pompton Plains, NJ (US)

(72) Inventor: Melissa Gronda, Pompton Plains, NJ (US)

(21) Appl. No.: 17/734,453

(22) Filed: May 2, 2022

Related U.S. Application Data
(63) Continuation-in-part of application No. 17/306,104, filed on May 3, 2021, now abandoned.

(51) Int. Cl. B44C 1/17; B29C 63/00

(52) U.S. Cl. CPC B44C 1/1741; B29C 63/0017; B29C 63/0047; C09J 5/00

(57) ABSTRACT

Methods for providing a slip-resistant, water-resistant, and antibacterial surface to a piece of sporting equipment include receiving a substrate printed with an image. The image is printed with ultraviolet curable ink and the substrate is non-silicone and includes a top printable layer printed with the image, a middle adhesive layer, and a bottom removable layer. The method includes aligning the substrate to a surface of the piece of sporting equipment, removing the bottom removable layer of the substrate, and contacting the middle adhesive layer that is exposed against the surface of the piece of sporting equipment. The method further includes smoothing the top printable layer printed with the image against the piece of sporting equipment. The substrate and the image printed with ultraviolet curable ink conforms to the shape of the piece of sporting equipment and provides the slip-resistant, water-resistant, and antibacterial surface.

### CROSS-REFERENCE TO RELATED APPLICATIONS

This application is a continuation-in-part of U.S. patent application Ser. No. 17/306,104, filed on May 3, 2021, which is hereby incorporated by reference herein in its entirety.

### TECHNICAL FIELD

The present disclosure generally relates to applying a slip-resistant, water-resistant, antibacterial surface to a piece of sporting equipment, and more particularly, to applying a slip-resistant, water-resistant, antibacterial surface to a surfboard.

### BACKGROUND

Unless otherwise indicated herein, the materials described in this section are not prior art to the claims in this application and are not admitted being prior art by inclusion in this section.

A user of a particular piece of sporting equipment may interact with a surface of said piece of sporting equipment. For example, a user may interact with a surface of a surfboard, a snowboard, a sled, a paddleboard, paddleboard handle, a skim board, a bodyboard, a skateboard, skis, a bat handle, lacrosse stick, pickleball paddle, tennis racquet, footwear, hockey stick, etc. Some sporting equipment may include a surface that interacts with another article while participating in the sport such as a blade of a hockey stick. A user of the sporting equipment may desire particular properties for the interactive surface of the piece of sporting equipment. These properties may include the interactive surface to be slip-resistant, water-resistant, and/or antibacterial.

A surfboard may be a narrow plank used in surfing. A surfboard may be light in weight and strong enough to support a user standing upon the surfboard while riding a wave. Traditional Hawaiian surfboards may be constructed from wood from local trees, such as koa. Technological advances in surfboards may include the addition of one or more fins (skegs) on the bottom rear of the board to improve directional stability, and improvements in materials and shape.

Modern surfboards may be made of polyurethane or polystyrene foam covered with layers of fiberglass cloth, and polyester or epoxy resin resulting in a light and strong surfboard that is buoyant and maneuverable. Further developments in surfboard technology may include carbon fiber and KEVLAR® composites, as well as experimentation in biodegradable and ecologically friendly resins made from organic sources.

The surface that a user stands upon on a surfboard is called the deck. The deck of a surfboard may include contours such as concavities or rail channels. Surfboard wax may be applied to the interactive deck surface to provide a slip-resistant surface and prevent a user from slipping off the surfboard when paddling or riding a wave. Surfboard wax may be a formulation of natural and/or synthetic wax for application to the deck of a surfboard, bodyboard, or skim board.

### SUMMARY

Existing challenges associated with the foregoing, as well as other challenges, are overcome by the presently disclosed method of applying a slip-resistant, water-resistant, antibacterial surface to sporting equipment to provide users with a piece of sporting equipment that includes a slip-resistant, water-resistant, antibacterial interactive surface.

One embodiment of the present disclosure is a method for providing a slip-resistant, water-resistant, and antibacterial surface to a piece of sporting equipment. The method includes receiving a substrate printed with an image. The image is printed with ultraviolet curable ink. The substrate is non-silicone and includes a top printable layer printed with the image, a middle adhesive layer, and a bottom removable layer. The method includes aligning the substrate printed with an image to a surface of a piece of sporting equipment. The method includes removing the bottom removable layer of the substrate printed with an image to expose the middle adhesive layer. The method includes contacting the middle adhesive layer that is exposed against the surface of the piece of sporting equipment. The method includes smoothing the top printable layer printed with the image and the middle adhesive layer against the piece of sporting equipment. The substrate printed with the image and the image printed with ultraviolet curable ink conforms to the shape of the piece of sporting equipment and provides the slip-resistant, water-resistant, and antibacterial surface.

In aspects, the smoothing further includes applying pressure to the top printable layer printed with the image with the middle adhesive layer exposed against the surface of the piece of sporting equipment.

In aspects, the smoothing is performed with a roller or a smoothing edge and prevents bubbles of air forming between the surface of the piece of sporting equipment and the middle adhesive layer.

In aspects, the method further includes printing the image on the substrate with an ultraviolet curable printer prior to receiving the substrate printed with the image.

In aspects, the method further includes receiving, by the ultraviolet curable printer, printing instructions for the image from an application prior to printing the image on the substrate.

In aspects, the image is a custom image provided by the application and the custom image is selected by a user from options provided by the application.

In aspects, the printing instructions are received over a network such as a private network, a local network, or Bluetooth®.

In aspects, the piece of sporting equipment is one of a surfboard, a snowboard, a sled, a paddleboard, a paddleboard handle, a skim board, a bodyboard, a skateboard, skis, a bat handle, lacrosse stick, a pickleball paddle handle, a tennis racquet handle, footwear, a crew or rowing handle, a fencing handle, a vault stick handle, balance boards, and a hockey stick.

In aspects, the substrate includes vinyl, white textured vinyl, polyvinyl, or aluminum.

Another embodiment of the present disclosure includes an apparatus for providing a slip-resistant, water-resistant, and antibacterial surface to a piece of sporting equipment. The apparatus includes a substrate printed with an image. The image is printed with ultraviolet curable ink. The substrate is non-silicone and includes a top printable layer, a middle adhesive layer, and a bottom removable layer. The top printable layer is printed with the image. The bottom removable layer is removable from the substrate printed with the image to expose the middle adhesive layer. The middle adhesive layer is configured to adhere the top printable layer to a surface of the piece of sporting equipment. The substrate printed with the image and the image printed with ultraviolet curable ink conforms to the shape of the piece of sporting equipment and provides the slip-resistant, water-resistant, and antibacterial surface.

Another embodiment of the present disclosure is a kit for providing a slip-resistant, water-resistant, and antibacterial surface to a piece of sporting equipment. The kit comprises a substrate printed with an image and a smoothing device. The substrate comprises a top printable layer, a middle adhesive layer, and a bottom removable layer. The top printable layer is printed with the image. The bottom removable layer is removable from the substrate printed with the image to expose the middle adhesive layer. The middle adhesive layer is configured to adhere the top printable layer to a surface of the piece of sporting equipment. The image printed on the top printable layer is printed with ultraviolet curable ink and provides the slip-resistant, water-resistant, and antibacterial surface.

In aspects, the smoothing device is a roller, and the roller includes a handle and a rubber, plastic, polymer, composite, or foam rolling tube.

In aspects, the smoothing device is a smoothing edge, the smoothing edge includes a straight edge for smoothing a surface, and the smoothing edge is metal, plastic, polymer, or a composite material.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 is a side perspective view of a printer printing an image on a substrate;

FIG. 2 is a system for applying a surface including an image printed on a substrate to a piece of sporting equipment;

FIG. 3 is a system for applying a surface including an image printed on a substrate to a piece of sporting equipment;

FIG. 4A is a side perspective view of a surface including an image printed on a substrate attached to a piece of sporting equipment;

FIG. 4B is a side perspective view of a surface including an image printed on a substrate attached to a piece of sporting equipment;

FIG. 4C is a side perspective view of a surface including an image printed on a substrate attached to a piece of sporting equipment;

FIG. 4D is a side perspective view of a surface including an image printed on a substrate attached to a piece of sporting equipment; and

FIG. 5 illustrates a flow diagram for an example method for providing a slip-resistant, water-resistant, and antibacterial surface to a piece of sporting equipment, all arranged according to at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

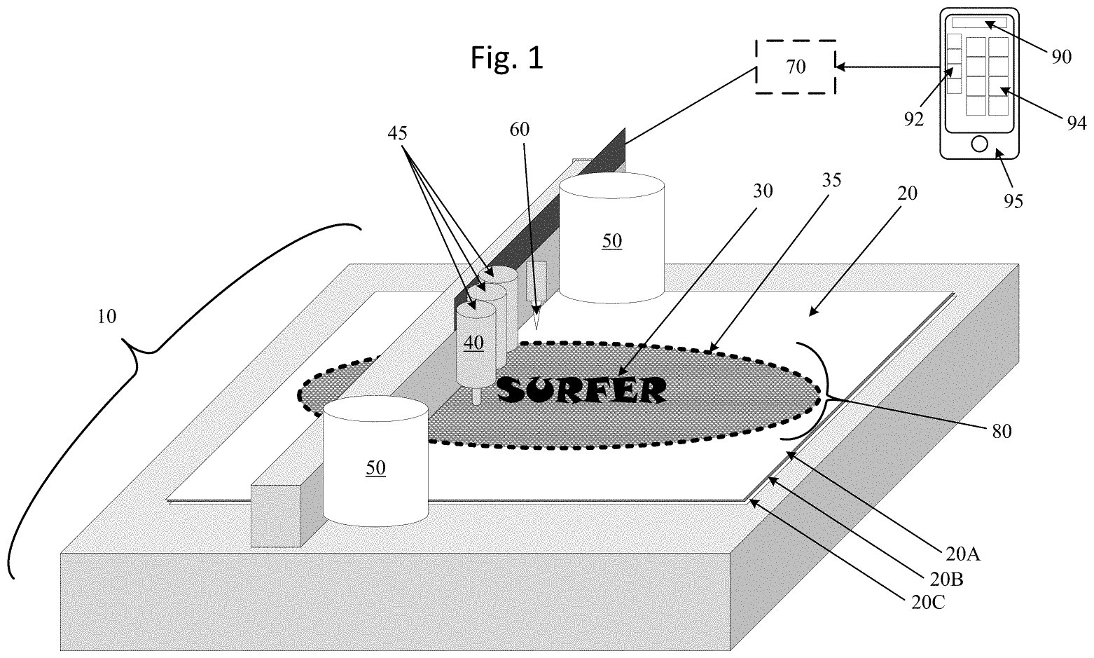

FIG. 1 is a side perspective view of a printer printing an image on a substrate, arranged in accordance with at least some embodiments described herein. Printer 10 may print a printed image 30 on substrate 20. Printer 10 may be an ultraviolet (UV) curable printer and may include ultraviolet curable inks 40 in ink cartridges 45.

Ultraviolet curable inks 40 may be ink which is configured to be cured and adhered to a substrate by UV radiation. Ultraviolet curable inks 40 may be printed on non-absorbent materials, including plastic, glass, and metal. Ultraviolet curable inks 40 may be non-silicone. Ultraviolet curable inks 40 may have a composition including select monomers and oligomers for specific ink colors along with a reactive diluent and a photoinitiator.

Printer 10 may further include ultraviolet lights 50. Ultraviolet lights 50 may illuminate a printing area of printer 10 and ultraviolet light provided by ultraviolet lights 50 may instantaneously cure ultraviolet curable ink 40 as ultraviolet curable ink 40 is printed upon substrate 20 by printer 10. Printer 10 may receive printing instructions 70 from an application, or web page 90 or other source. Printing instruction 70 may be instructions for printed image 30 and may be received by printer 10 directly or over a network, such as the internet, private network, local network, Bluetooth®, etc.

In practice, a user may log into an application or a webpage 90 with computer or a smart device 95 and choose options to design a customized image for printing on a slip-resistant, water resistant, antibacterial surface such as substrate 20. An application or web page 90 may include categories 92 and options 94 for a user to select such as piece of sporting equipment surface is to be applied to, color(s), selectable template(s), selectable clipart(s), selectable image(s), selectable background(s), selectable shape(s), selectable slogan(s), inputting of text to be printed (e.g., a name, initials, team name etc.), fonts to print in, an option to upload an image for printing, etc. A user may make selections through application or webpage 90 to design a custom image for printing on a slip-resistant, water resistant, antibacterial surface for a piece of sporting equipment. The application or webpage 90 may receive inputs and produce printing instructions 70 for printed image 30 and sent printing instruction 70 to printer 10.

Printed image 30 may be any image printed onto substrate 20 by printer 10 with ultraviolet curable ink 40. Printed image 30 may be a unique custom image and may include a printed pattern of colors or shapes, a design, a picture, a caricature, a cartoon, a drawing, words or a name in any font or design, logos, mascots, etc. Printed and cured ink 40 may form printed image 30 upon substrate 20 when printer 10 executes instructions 70. Printed and ultraviolet light cured ink 40 may form a surface with slip-resistant, water-resistant, and antibacterial properties.

Substrate 20 may be a printable, non-silicone, slip resistant media. Substrate 20 may include a top layer 20A, a middle layer 20B, and a bottom layer 20C. Top layer 20A may include vinyl, white textured vinyl, polyvinyl, or aluminum and may be a printable surface. Top layer 20A may be resistant to wear and durable and may be UL410 certified for slip resistance. Top layer 20A may be from 0.015 inches/0.381 mm to 0.075 inches/1.905 mm in thickness.

Middle layer 20B may be an adhesive layer and may include a pressure sensitive adhesive. Middle layer 20B may be from 0.001 inches/0.0254 mm to 0.001 inches/0.1016 mm in thickness.

Bottom layer 20C may be a removable layer and may include a material configured to be removable from adhesive layer 20B, such as a release liner. Bottom layer 20c may be from 0.005 inches/0.127 mm to 0.008 inches/0.2032 mm in thickness.

When removable layer 20C is removed from adhesive layer 20B, adhesive layer 20B may be exposed. Adhesive layer 20B may be configured to adhere and secure printable surface 20A to a surface which adhesive layer 20B is contacted upon. Top layer 20A including any ink printed upon printable surface of top layer 20A may be adhered to a surface by adhesive layer 20B. In examples, substrate 20 may be any printable, commercial grade, slip resistant media for applying to surfaces such as asphalt, concrete, stairs, stone, metal, flooring, and/or smooth surfaces. In another example, substrate 20 may be grip tape used for skateboards.

Printer 10 may further include a cutting tool 60 and printer 10 and may be configured to score substrate 20 with cutting tool 60. Printer 10 may score substrate 20 with cutting tool 60 along an outside edge 35 of printed image 30 so that a printed substrate 80 with printed image 30 may be separated from remaining unprinted substrate 20.

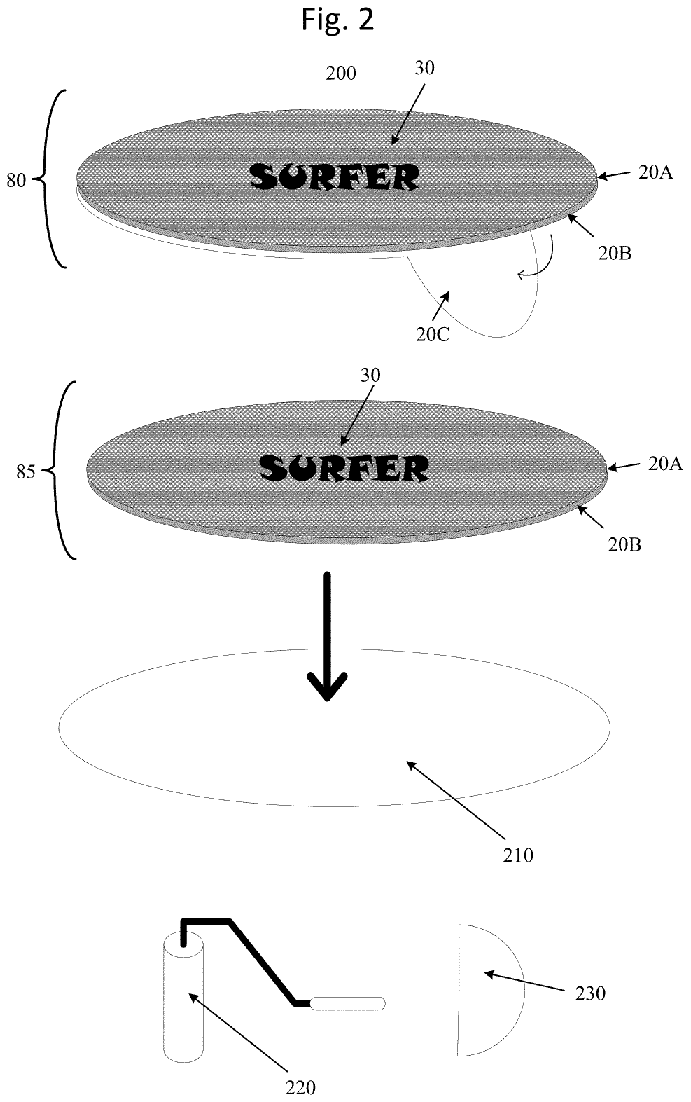

FIG. 2 is a system for applying a surface including an image printed on a substrate to a piece of sporting equipment, arranged in accordance with at least some embodiments described herein. Those components in FIG. 2 that are labeled identically to components of FIG. 1 will not be described again for the purposes of brevity.

System 200 may include printed substrate 80, sporting equipment 210, a roller 220, and a smoothing edge 230. Roller 220 may be a device for smoothing printed substrate 80 onto a surface and may include a handle and a rubber, plastic, polymer, composite, or foam rolling tube. Smoothing edge 230 may be another device for smoothing printed substrate 80 onto a surface. Smoothing edge 230 may include a straight edge for smoothing a surface and may be metal, plastic, polymer, or a composite material. As previously described, printed substrate 80 may include printed image 30 printed upon top layer 20A. Printed substrate 80 may further include middle adhesive layer 20B and bottom removeable layer 20C.

Sporting equipment 210 may be new or used and may be, but is not limited to, a surfboard, a snowboard, a sled, a paddleboard, a paddleboard handle, a skim board, a bodyboard, a skateboard, skis, a bat handle, a hockey stick, lacrosse stick, a pickleball paddle handle, a tennis racquet handle, a crew or rowing handle, a fencing handles, a vault stick handle, balance boards, footwear, etc. Sporting equipment 210 may include a surface that interacts with a user, such as a deck of a surfboard, or a handle or shaft which is gripped by a hand of a user. Sporting equipment 210 may include a surface that interacts with another article while participating in the sport, such as a blade of a hockey stick with a puck. As described in more detail below, removable layer 20C may be pulled away from printed substrate 80 to expose adhesive layer 20B and produce adhesive image 85. Adhesive image 85 may include printed image 30 printed upon top layer 20A and adhesive layer 20B. Adhesive image 85 may be applied to a surface of sporting equipment 210 and adhered to sporting equipment 210 by adhesive layer 20B.

Adhesive image 85 applied and adhered to sporting equipment 210 may provide a slip-resistant, water-resistant, and antibacterial surface to sporting equipment 210. Adhesive image 85 applied and adhered to sporting equipment 210 may conform to the shape of sporting equipment 210 and providing a user with a superior gripping surface than a traditional sleeve shaped handle grip. Adhesive image 85 applied and adhered to sporting equipment 210 may provide a durable surface which may be tear resistant and provide a protect layer to sporting equipment 210. Adhesive image 85 may protect the longevity, integrity and endurance of sporting equipment 210 when applied and protect sporting equipment 210 from wear and damage. Adhesive image 85 may include durable and thick material and when adhered to sporting equipment 210 may not deteriorate or come off of sporting equipment 210 without a removal process. Adhesive image 85 may provide a protective layer to sporting equipment 210 and extend a lifespan of sporting equipment 210.

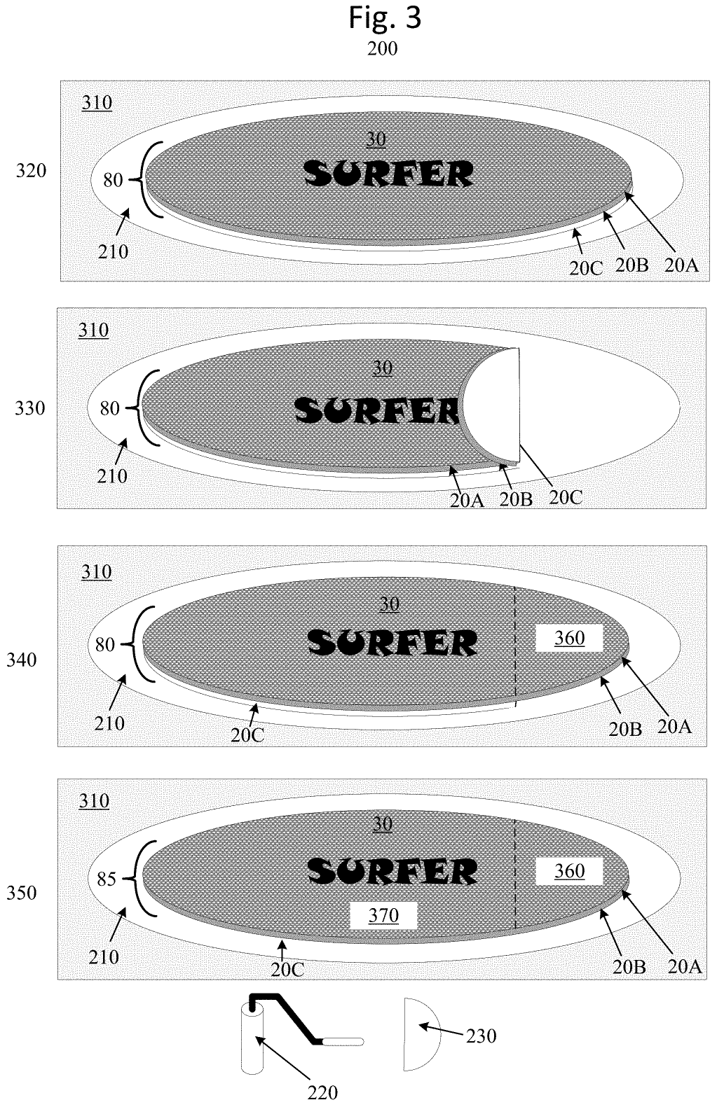

FIG. 3 is a system for applying a surface comprising an image printed on a substrate to a piece of sporting equipment, arranged in accordance with at least some embodiments described herein. Those components in FIG. 3 that are labeled identically to components of FIGS. 1-2 will not be described again for the purposes of brevity.

Sporting equipment 210 may be a large object, such as a surfboard, and may be stabilized on a surface 310. At 320, printed substrate 80 may be positioned and aligned with a surface of sporting equipment 210 where a slip-resistant, water-resistance, antibacterial surface is desired. For example, when piece of sporting equipment 210 is a surfboard, printed substrate 80 may be positioned and aligned with a deck of sporting equipment 210. Removable layer 20C may be positioned adjacent to sporting equipment 210.

At 330, a first end of printed substrate 80 may be rolled back over printed substrate 80 to expose removable layer 20C and a first portion of removable layer 20 C may be pulled away or removed from printed substrate 80 to expose a first portion of adhesive layer 20B.

At 340, the exposed first portion of adhesive layer 20B may be contacted with surface of sporting equipment 210 to adhere a first portion 360 of top layer 20A and printed image 30 to a surface sporting equipment 210. First portion 360 with exposed adhesive layer 20B may be contacted against surface of sporting equipment 210 to ensure complete contact of exposed adhesive layer 20B to surface of sporting equipment 210. Roller 220, smoothing edge 230, or a hand of a person performing the adhesion may apply pressure and smooth first portion 360 with exposed adhesive layer 20B against surface of sporting equipment 210 to ensure complete contact of adhesive layer 20B to surface of sporting equipment 210 and to prevent bubbles of air forming between the surface of sporting equipment 210 and adhesive layer 20B.

At 350, the remaining portion of removable layer 20C may be removed from printed substrate 80 resulting in adhesive image 85. The remaining portion of adhesive layer 20B may be contacted with surface of sporting equipment 210. A remaining portion 370 of top layer 20A and printed image 30 may be adhered to a surface of sporting equipment 210. As before, roller 220, smoothing edge 230, or a hand of a person performing the adhesion may press second portion 370 with exposed adhesive layer 20B against surface of sporting equipment 210 to ensure complete contact of adhesive layer 20B to surface of sporting equipment 210 and to prevent bubbles of air forming under second portion 370. Adhesive image 85 including printed image 30 printed upon top layer 20A and adhesive layer 20B may provide a slip-resistant, water-resistant, and antibacterial surface to sporting equipment 210.

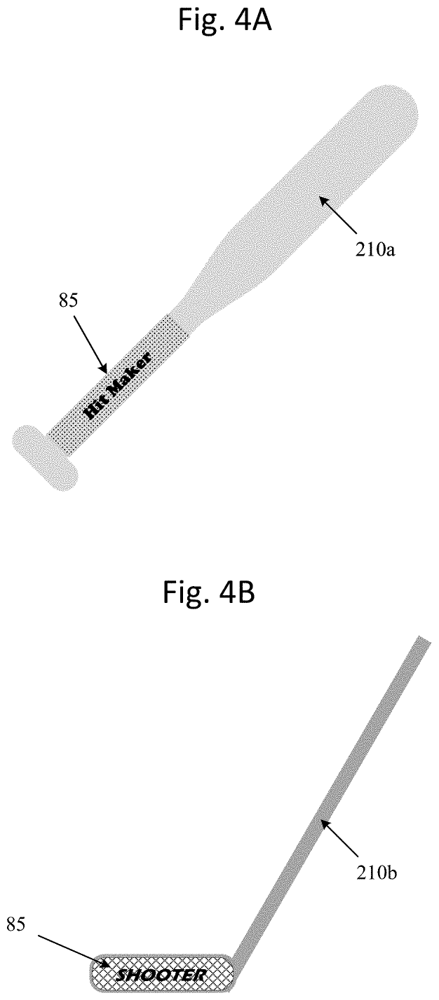

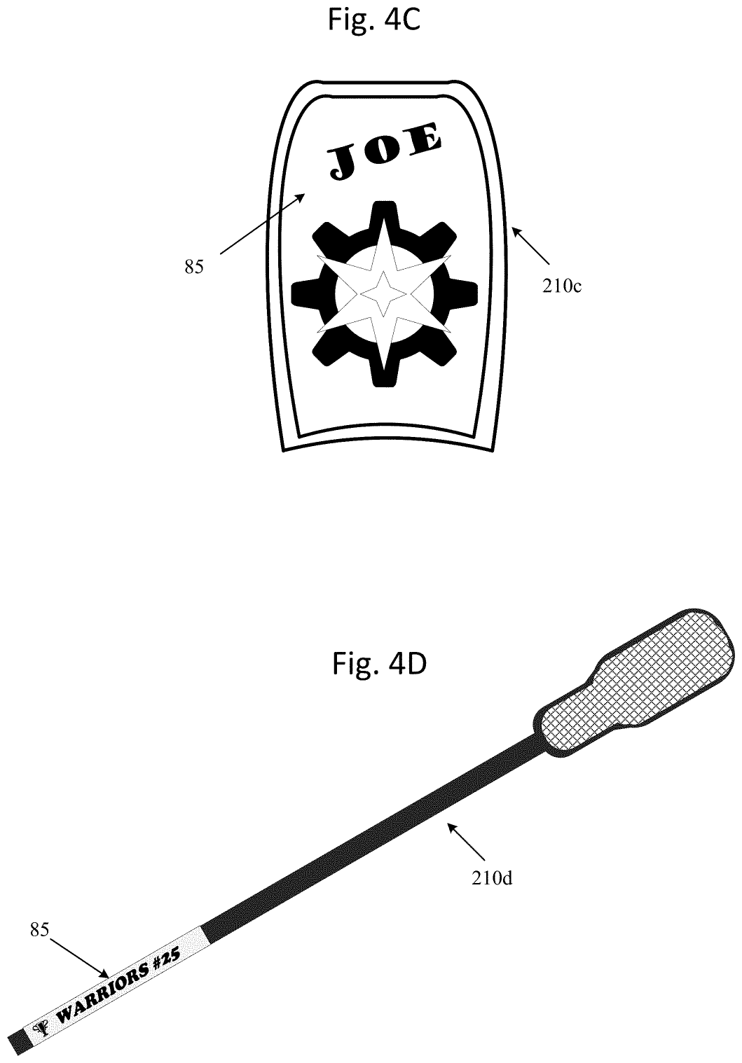

FIGS. 4A, 4B, 4C, and 4D are a side perspective views of a surface including an image printed on a substrate attached to a piece of sporting equipment, arranged in accordance with at least some embodiments described herein. Those components in FIGS. 4A-4D that are labeled identically to components of FIGS. 1-3 will not be described again for the purposes of brevity.

In an example, sporting equipment 210 may be a baseball or softball bat 210a. At FIG. 4A, adhesive image 85 may be applied and adhered to a handle of baseball bat 210a. Adhesive image 85 may provide a slip-resistant, water-resistant, and antibacterial surface to a handle of baseball bat 210a.

In another example, sporting equipment 210 may be a hockey stick 210b. At FIG. 4B, adhesive image 85 may be applied and adhered to a blade of hockey stick 210b. Adhesive image 85 may provide a slip-resistant, water-resistant, and antibacterial surface to blade of hockey stick 210b.

In another example, sporting equipment 210 may be a body board 210c. At FIG. 4C, adhesive image 85 may be applied and adhered to a deck of body board 210c. Adhesive image 85 may provide a slip-resistant, water-resistant, and antibacterial surface to the deck of body board 210c.

In another example, sporting equipment 210 may be a lacrosse stick 210d. At FIG. 4D, adhesive image 85 may be applied and adhered to a handle of lacrosse stick 210d. Adhesive image 85 may provide a slip-resistant, water-resistant, and antibacterial surface to the handle of lacrosse stick 210d.

A device in accordance with the present disclosure may provide a slip-resistant, water-resistant, and antibacterial surface to sporting equipment such as a surfboard, a snowboard, a sled, a paddleboard, paddleboard handle, a skim board, a bodyboard, a skateboard, skis, a bat handle, hockey stick, etc. A device in accordance with the present disclosure may provide a slip-resistant, water-resistant, and antibacterial surface to sporting equipment that does not include silicone. A device in accordance with the present disclosure may provide a slip-resistant, water-resistant, and antibacterial surface for a deck of a surfboard so that a user does not have to wax the deck. A device in accordance with the present disclosure may provide a slip-resistant, water-resistant, and antibacterial surface for a piece of sporting equipment which is personalized and can include a custom image. A device in accordance with the present disclosure may provide a kit with a customized adhesive image which can be applied to provide a slip-resistant, water-resistant, and antibacterial surface to a piece of sporting equipment.

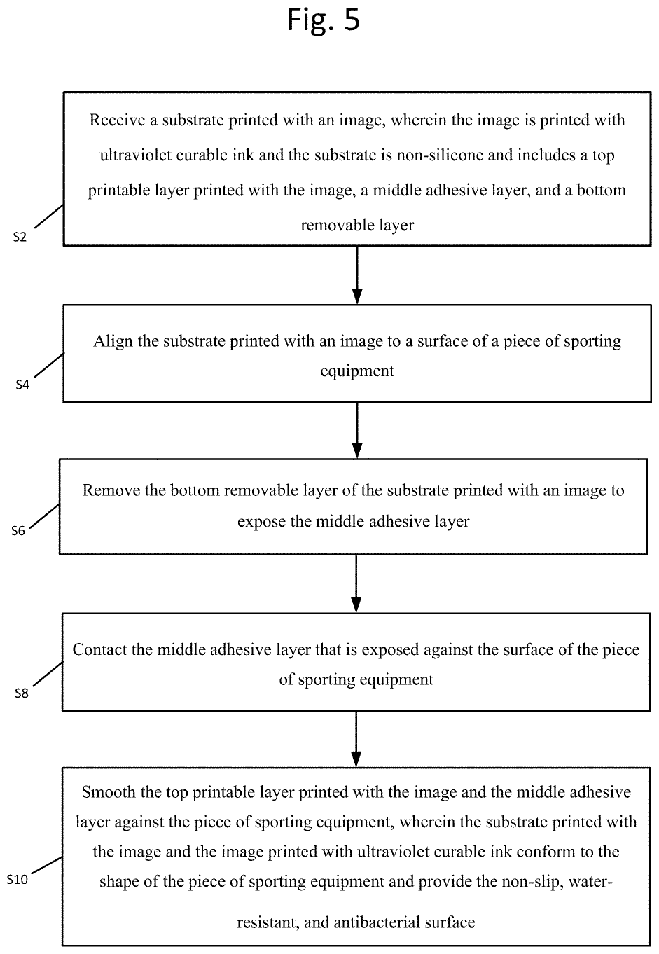

FIG. 5 illustrates a flow diagram for an example method for providing a slip-resistant, water-resistant, and antibacterial surface to a piece of sporting equipment, arranged in accordance with at least some aspects presented herein. An example process may include one or more operations, actions, or functions as illustrated by one or more of blocks S2, S4, S6, S8, and/or S10. Although illustrated as discrete blocks, various blocks may be divided into additional blocks, combined into fewer blocks, or eliminated, depending on the desired implementation.

Processing may begin at block S2, “Receive a substrate printed with an image, wherein the image is printed with ultraviolet curable ink and the substrate is non-silicone and includes a top printable layer printed with the image, a middle adhesive layer, and a bottom removable layer”. At block S2, a substrate printed with an image may be received. The image may be printed with ultraviolet curable ink. The substrate may be non-silicone and may include a top printable layer printed with the image, a middle adhesive layer, and a bottom removable layer.

Processing may continue from block S2 to block S4, “Align the substrate printed with an image to a surface of a piece of sporting equipment”. At block S4, the substrate printed with an image may be aligned to a surface of a piece of sporting equipment. The substrate printed with an image may be aligned and positioned to a surface of the piece of sporting equipment where a slip-resistant, water-resistance, antibacterial surface is desired.

Processing may continue from block S4 to block S6, “Remove the bottom removable layer of the substrate printed with an image to expose the middle adhesive layer”. At block S6, the bottom removable layer of the substrate printed with an image may be removed to expose the middle adhesive layer. The middle adhesive layer may be configured to adhere and secure the substrate printed with an image to a surface which the adhesive layer is contacted upon.

Processing may continue from block S6 to block S8, “Contact the middle adhesive layer that is exposed against the surface of the piece of sporting equipment”. At block S8, the middle adhesive layer that is exposed may be contacted against the surface of the piece of sporting equipment. The middle adhesive layer may be configured to adhere and secure the substrate printed with an image to a surface which the adhesive layer is contacted upon.

Processing may continue from block S8 to block S10, “Smooth the top printable layer printed with the image and the middle adhesive layer against the piece of sporting equipment, wherein the substrate printed with the image and the image printed with ultraviolet curable ink conform to the shape of the piece of sporting equipment and provide the slip-resistant, water-resistant, and antibacterial surface”. At block S10, the top printable layer printed with the image and the middle adhesive layer may be smoothed against the piece of sporting equipment. The smoothing may ensure complete contact of the middle adhesive layer to the surface of the piece of sporting equipment and may prevent bubbles of air forming between the surface of the piece of sporting equipment and the middle adhesive layer. The substrate printed with the image and the image printed with ultraviolet curable ink conform to the shape of the piece of sporting equipment and provide the slip-resistant, water-resistant, and antibacterial surface.

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. A method for providing a slip-resistant, water-resistant, and antibacterial surface to a piece of sporting equipment, the method comprising:
receiving a substrate printed with an image, wherein the image is printed with ultraviolet curable ink and the substrate is non-silicone and includes a top printable layer printed with the image, a middle adhesive layer, and a bottom removable layer;
aligning the substrate printed with an image to a surface of a piece of sporting equipment;
removing the bottom removable layer of the substrate printed with an image to expose the middle adhesive layer;
contacting the middle adhesive layer that is exposed against the surface of the piece of sporting equipment; and
smoothing the top printable layer printed with the image and the middle adhesive layer against the piece of sporting equipment, wherein the substrate printed with the image and the image printed with ultraviolet curable ink conform to the shape of the piece of sporting equipment and provide the slip-resistant, water-resistant, and antibacterial surface.

2. The method of claim 1, wherein the smoothing further comprises applying pressure to the top printable layer printed with the image with the middle adhesive layer exposed against the surface of the piece of sporting equipment.

3. The method of claim 2, wherein the smoothing is performed with a roller or a smoothing edge and prevents bubbles of air forming between the surface of the piece of sporting equipment and the middle adhesive layer.

4. The method of claim 1, further comprising printing the image on the substrate with an ultraviolet curable printer prior to receiving the substrate printed with the image.

5. The method of claim 4, further comprising receiving, by the ultraviolet curable printer, printing instructions for the image from an application prior to printing the image on the substrate.

6. The method of claim 5, wherein the image is a custom image provided by the application and the custom image is selected by a user from options provided by the application.

7. The method of claim 5, wherein the printing instructions are received over a network such as a private network or a local network.

8. The method of claim 1, wherein the piece of sporting equipment is one of a surfboard, a snowboard, a sled, a paddleboard, a paddleboard handle, a skim board, a bodyboard, a skateboard, skis, a bat handle, lacrosse stick, a pickleball paddle handle, a tennis racquet handle, footwear, a crew or rowing handle, a fencing handle, a vault stick handle, balance boards, and a hockey stick.

9. The method of claim 1, wherein the substrate includes vinyl, white textured vinyl, polyvinyl, or aluminum.

10. An apparatus for providing a slip-resistant, water-resistant, and antibacterial surface to a piece of sporting equipment, the apparatus comprising:
a substrate printed with an image, wherein the image is printed with ultraviolet curable ink and the substrate is non-silicone and comprises:
a top printable layer, wherein the top printable layer is printed with the image;
a middle adhesive layer;
a bottom removable layer; and
wherein, the bottom removable layer is removable from the substrate printed with the image to expose the middle adhesive layer, the middle adhesive layer is configured to adhere the top printable layer to a surface of the piece of sporting equipment, and the substrate printed with the image and the image printed with ultraviolet curable ink conform to the shape of the piece of sporting equipment and provide the slip-resistant, water-resistant, and antibacterial surface.

11. The apparatus of claim 10, wherein the image printed on the substrate is printed with an ultraviolet curable printer from printing instructions received from an application.

12. The apparatus of claim 11, wherein the image is a custom image provided by the application and the custom image is selected by a user from options provided by the application.

13. The apparatus of claim 11, wherein the printing instructions are received over a network such as a private network or a local network.

14. The apparatus of claim 10, wherein the piece of sporting equipment is one of a surfboard, a snowboard, a sled, a paddleboard, a paddleboard handle, a skim board, a bodyboard, a skateboard, skis, a bat handle, lacrosse stick, a pickleball paddle handle, a tennis racquet handle, footwear, a crew or rowing handle, a fencing handle, a vault stick handle, balance boards, and a hockey stick.

15. A kit for providing a slip-resistant, water-resistant, and antibacterial surface to a piece of sporting equipment, the kit comprising:
a substrate printed with an image, wherein the image is printed with ultraviolet curable ink and the substrate is non-silicone and comprises:
a top printable layer, wherein the top printable layer is printed with the image;
a middle adhesive layer;
a bottom removable layer;
a smoothing device; and
wherein, the bottom removable layer is removable from the substrate printed with the image to expose the middle adhesive layer, the middle adhesive layer is configured to adhere the top printable layer to a surface of the piece of sporting equipment, and the substrate printed with the image and the image printed with ultraviolet curable ink conform to the shape of the piece of sporting equipment and provide the slip-resistant, water-resistant, and antibacterial surface.

16. The kit of claim 15, wherein the image printed on the substrate is printed with an ultraviolet curable printer from printing instructions received from an application.

17. The kit of claim 16, wherein the image is a custom image provided by the application, the custom image is selected by a user from options provided by the application, and the printing instructions are received over a network such as a private network or a local network.

18. The kit of claim 15, wherein the smoothing device is a roller, and the roller includes a handle and a rubber, plastic, polymer, composite, or foam rolling tube.

19. The kit of claim 15, wherein the smoothing device is a smoothing edge, the smoothing edge includes a straight edge for smoothing a surface, and the smoothing edge is metal, plastic, polymer, or a composite material.

20. The kit of claim 15, wherein the piece of sporting equipment is one of a surfboard, a snowboard, a sled, a paddleboard, a paddleboard handle, a skim board, a bodyboard, a skateboard, skis, a bat handle, lacrosse stick, a pickleball paddle handle, a tennis racquet handle, footwear, a crew or rowing handle, a fencing handle, a vault stick handle, balance boards, and a hockey stick.
